(19) United States
(12) Patent Application Publication
(10) Pub. No.: US 2026/0087558 A1
(43) Pub. Date: Mar. 26, 2026

(54) COVERAGE DATA GENERATION SYSTEM

(71) Applicant: State Farm Mutual Automobile Insurance Company, Bloomington, IL (US)

(72) Inventors: Jon DeRew, Bloomintgon, IL (US); Tracy Warne, Bloomington, IL (US); Lisa Rossi, Decatur, GA (US); Thomas Schaefer, Hapeville, GA (US); Jae Warren, Decatur, GA (US); Ashlie O'Dell, St. Paul, TX (US); Linda Che, Bloomington, IL (US); Stacy Tarvin, Normal, IL (US); Andrew Galligan, Morton, IL (US); Ravi Patel, Bloomington, IL (US); Bridget Richardson, Downs, IL (US); Ivy Lee, Alma, TX (US); Amanda Aviles, Bloomington, IL (US)

(21) Appl. No.: 18/895,891

(22) Filed: Sep. 25, 2024

(51) Int. Cl. G06Q 40/08

(52) U.S. Cl. CPC G06Q 40/08

(57) ABSTRACT

Described herein are systems and techniques to facilitate the generation of coverage data for various types of coverages and situations. A request for coverage data may be processed to determine a user and/or vehicle. A policy may be identified and policy coverage data may be determined. A region associated with the policy may be identified and regional coverage requirements may be determined. Based on the policy coverage data and the regional coverage requirements, applicable coverage data may be determined, reconciling any inconsistency between the policy coverage data and the regional coverage requirements if needed. The applicable coverage data may then be provided to the source of the request.

### BACKGROUND

Insurance coverage for vehicles operated on public roads is mandatory in most jurisdictions. To accommodate the purchase or lease of a newly acquired vehicle, most vehicle insurance policies include temporary, or interim, coverage for such a newly acquired vehicle for a period of time, allowing the purchaser to complete the vehicle purchase and providing time to formalize a long term insurance policy to cover the newly acquired vehicle. When selling or leasing a vehicle, a dealer will typically require proof of this interim vehicle insurance coverage. However, many vehicle owners may not have ready access to documentation providing such proof of insurance. For example, a typical insurance card or other standard proof of insurance does not include interim insurance information. Moreover, many vehicle purchase and lease transactions are conducted over the weekends or during other non-business hours when it may be difficult to contact an insurance agent or representative to acquire such proof of insurance. The examples of the present disclosure are directed to overcoming these and other coverage data determination deficiencies and providing an automated system for generating coverage data and interfaces and communication that may provide such data to a user.

### SUMMARY

Techniques described herein facilitate the generation of coverage data for various types of coverages and situations. A request for coverage data may be processed to determine a user and/or vehicle. A policy may be identified and policy coverage data may be determined. A region associated with the policy may be identified and regional coverage requirements may be determined. Based on the policy coverage data and the regional coverage requirements, applicable coverage data may be determined, reconciling any inconsistency between the policy coverage data and the regional coverage requirements if needed. The applicable coverage data may then be provided to the source of the request.

For example, the techniques described herein may relate to receiving, at a cloud-based coverage data generation system, a request for coverage data associated with a service executing at the cloud-based coverage data generation system, the request for coverage data comprising user information and coverage data type; determining, at the cloud-based coverage data generation system, and based on the user information, a user identifier; determining, at the cloud-based coverage data generation system, and based on the user identifier and communication with a first data store, first coverage data associated with the coverage data type; determining, at the cloud-based coverage data generation system, and based on the first coverage data and communication with a second data store, second coverage data associated with the coverage data type; determining, at the cloud-based coverage data generation system, and based on the coverage data type, the first coverage data, and the second coverage data, third coverage data; generating, at the cloud-based coverage data generation system and based on the third coverage data, presentation data that, when processed by a user computing device, cause the user computing device to output a subset of the third coverage data on an output component of the user computing device; and transmitting, from the cloud-based coverage data generation system to the user computing device, the presentation data.

In examples, determining the third coverage data may include determining that a first coverage attribute of the first coverage data is inconsistent with a corresponding second coverage attribute of the second coverage data; and selecting one of the first coverage attribute or the second coverage attribute for inclusion in the third coverage data based on a comparison of the first coverage attribute and the second coverage attribute. In examples, the first coverage data may include policy coverage data associated with a policy currently associated with the user identifier, and the second coverage data may include regional coverage data associated with a region associated with the user identifier. The techniques may include determining an agent device associated with the policy; and transmitting an indication of the third coverage data to the agent device. The coverage data may be extended coverage data for temporary coverage of a vehicle and/or predicted coverage data for future coverage of a vehicle. The request for coverage data may include vehicle data, and determining at least one of the first coverage data or the second coverage data further based on the vehicle data.

The techniques described herein may relate to a non-transitory computer-readable medium comprising instructions that, when executed by one or more processors at a cloud-based coverage data generation system, cause the one or more processors to perform operations including receiving a request for coverage data associated with a service executing at the cloud-based coverage data generation system, the request for coverage data comprising user information and coverage data type; determining, based on the user information, a first identifier; determining, based on the first identifier and communication with a first data store, first coverage data associated with the coverage data type; determining, based on the first coverage data and communication with a second data store, second coverage data associated with the coverage data type; determining, based on the coverage data type, the first coverage data, and the second coverage data, third coverage data; generating, based on the third coverage data, presentation data that, when processed by a user computing device, cause the user computing device to output a subset of the third coverage data on an output component of the user computing device; and transmitting, to the user computing device, the presentation data.

In examples, determining the third coverage data includes determining that a first coverage attribute of the first coverage data is inconsistent with a corresponding second coverage attribute of the second coverage data; and selecting one of the first coverage attribute or the second coverage attribute for inclusion in the third coverage data based on a comparison of the first coverage attribute and the second coverage attribute. The first coverage data may include coverage data associated with a policy currently associated with the user identifier, and the second coverage data may include regional data associated with a region associated with the user identifier. The operations may further include determining an agent device associated with the policy; and generating an indication of the third coverage data to the agent device. The first identifier may be a vehicle identifier that is a vehicle identifier number (VIN) or a license plate number.

The techniques described herein may relate to a system that may include one or more processors; and a non-transitory memory storing computer-executable instructions that, when executed, cause the one or more processors to perform operations including receiving a request for coverage data associated with a service executing at a cloud-based coverage data generation system, the request for coverage data comprising user information and coverage data type; determining, based on the user information, a first identifier; determining, based on the first identifier and communication with a first data store, first coverage data associated with the coverage data type; determining, based on the first coverage data and communication with a second data store, second coverage data associated with the coverage data type; determining, based on the coverage data type, the first coverage data, and the second coverage data, third coverage data; generating, based on the third coverage data, presentation data that, when processed by a user computing device, cause the user computing device to output a subset of the third coverage data on an output component of the user computing device; and transmitting, to the user computing device, the presentation data.

In examples, the third coverage data includes at least one of a coverage duration, a coverage deductible, and a coverage limit. The presentation data may include an instruction to activate, at the user computing device, at least one of a visual output component, an audio output component, or a haptic output component. The presentation data may include instructions to generate and present an interface representing the subset of the third coverage data at the user computing device. The coverage data type may indicate one or more of extended coverage data, current coverage data, predicted coverage data, or historical coverage data. The operations can also include receiving a second request comprising one or more of a telephone number or an email address; generating, based on the second request, second presentation data that, when processed by a second user computing device, causes the second user computing device to output a subset of the third coverage data on a second output component of the second user computing device; and transmitting, to the second user computing device, using at least one of the telephone number or the email address, the second presentation data.

The techniques described herein may relate to a system for generating coverage data that may include means for receiving a request for coverage data associated with a service executing at a cloud-based coverage data generation system, the request for coverage data comprising user information and coverage data type; means for determining, based on the user information, a user identifier; means for determining, based on the user identifier and communication with a first data store, first coverage data associated with the coverage data type; means for determining, based on the first coverage data and communication with a second data store, second coverage data associated with the coverage data type; means for determining, based on the coverage data type, the first coverage data, and the second coverage data, third coverage data; means for generating, based on the third coverage data, presentation data that, when processed by a user computing device, cause the user computing device to output at least a subset of the third coverage data on an output component of the user computing device; and means for transmitting, to the user computing device, the presentation data.

### BRIEF DESCRIPTION OF THE DRAWINGS

FIG. 1 illustrates an example environment in which a coverage data generation system and the described techniques may be implemented.

FIG. 2 is a flow diagram illustrating an example process for processing a request for coverage data and responsively generating and providing such coverage data according to the examples described herein.

FIG. 3 is a flow diagram illustrating an example process for generating a request for coverage data and receiving and processing a response to such a request according to the examples described herein.

FIG. 4 is a flow diagram illustrating an example process for processing a request for extended coverage data and predicted coverage data and responsively generating and providing such coverage data according to the examples described herein.

FIG. 5 is a flow diagram illustrating an example process for determining coverage data tasks and generating interfaces and communications notifying users of such tasks according to the examples described herein.

FIG. 6 illustrates an example interface that may be generated by the disclosed coverage data generation system and/or a user device to collect and generate a request for coverage data using the techniques described herein.

FIG. 7 illustrates an example interface that may be generated by the disclosed coverage data generation system and/or a user device to provide coverage data using the techniques described herein.

FIG. 8 shows an example system architecture for a computing device that may be used to implement the systems and architectures described herein.

The detailed description is set forth with reference to the accompanying figures. In the figures, the left-most digit(s) of a reference number identifies the figure in which the reference number first appears. The use of the same reference numbers in different figures indicates similar or identical items.

### DETAILED DESCRIPTION

Certain implementations and examples of the disclosure will now be described more fully below with reference to the accompanying figures, in which various aspects are shown. However, the various aspects may be implemented in many different forms and should not be construed as limited to the implementations set forth herein. The disclosure encompasses variations of the examples, as described herein. Like numbers refer to like elements throughout.

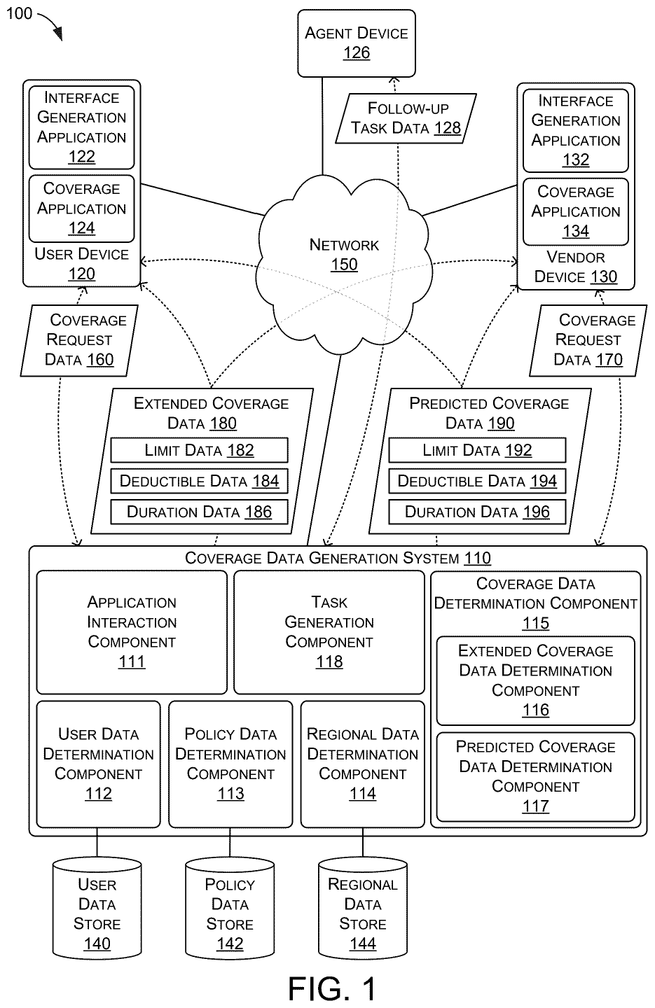

FIG. 1 illustrates an environment 100 in which coverage data generation systems and methods may be implemented according to examples of the instant disclosure. As used herein “coverage data” may include any data associated with insurance coverage for one or more vehicles, including, but not limited to, deductibles, coverage limits (e.g., monetary or financial limits), coverage duration, proof of insurance (e.g., proof of insurance documents and/or evidence), coverage limitations (e.g., geographical limitations, temporal imitations, etc.), legal and/or descriptive language associated with insurance coverage, and any other data that may represent aspects of vehicle insurance coverage of any type. Individual aspects of coverage data may be referred to herein as coverage data attributes. As used herein, “extended coverage data” is coverage data associated with interim or temporary vehicle insurance coverage intended to cover a newly acquired vehicle for a limited period of time. Such interim or temporary vehicle insurance coverage is typically included with (e.g., normal, standard, renewable, and/or non-time limited) vehicle insurance covering a currently owned or leased vehicle. As used herein, “predicted coverage data” is coverage data associated with a quote for (e.g., normal, standard, renewable, and/or non-time limited) vehicle insurance coverage (e.g., an estimate for future coverage of a vehicle). Predicted coverage data may include data indicating to a user the predicted costs and coverage information for insuring a vehicle, such as a vehicle the user is considering acquiring.

A coverage data generation system 110 may be configured in the environment 100. The coverage data generation system 110 may be configured to generate coverage data, such as extended coverage data and/or predicted coverage data. The generate such data, the coverage data generation system 110 interact with various other systems, components, and/or devices and may execute and/or operation various components to perform coverage data generation operations.

In examples, the coverage data generation system 110 may be a service executing at a cloud-based system, which may be a distributed system operating as a decentralized data processing and storage system. Alternatively, or additionally, any one or more of the components of the coverage data generation system 110 and/or the components, devices, and/or systems with which the coverage data generation system 110 may interact may be executing as services in a cloud-based system.

In examples, the coverage data generation system 110 may interact with a user device 120 that request coverage data from the coverage data generation system 110. For example, the user device 120 may be a device operated by an insurance customer for purposes of obtaining vehicle insurance coverage data. The user device 120 may be configured with an interface generation application 122 that may facilitate interaction with a user by generating interfaces and other data that may be presented, via components of the user device 120, as output to a user visually, audibly, haptically, and/or via any other output means. The interface generation application 122 may further facilitate interaction with a user by accepting or otherwise detecting input from a user via components of the user device 120, including touch input (e.g., using buttons and/or a touchscreen), audible input (e.g., using a microphone), visual input (e.g., using a camera or other light-sensitive input means), haptic input (e.g., using motion sensors to detect movement of the user device 120 by a user), etc. In various examples, the interface generation application 122 may be, or include, a web browser or other application that facilitates interaction with one or more remote systems or devices.

The user device 120 may also, or instead, be configured with a coverage application 124. The coverage application 124 may be an application configured to interact with the coverage data generation system 110. The coverage application 124 may be executed independently of the interface generation application 122 and may receive input and generate output independent of the interface generation application 122 (e.g., using components of the user device 120), including any input and output as described herein. Alternatively, the coverage application 124 may be executed in conjunction with the interface generation application 122 that may interact with the coverage application 124 to perform various operations.

The user device 120 may include one or more wireless and/or wired communications components that may facilitate interaction with remote devices and/or systems. For example, the user device 120 may include various wireless communications components that may facilitate communications (e.g., the exchange of coverage data-related communications) with one or more remote systems via the network 150. These communications may be wireless communications transmissions, using, for example, cellular communications, Bluetooth communications, and/or Wi-Fi. The network 150 may any one or more wireless and/or wired networks that may be configured to facilitate communications between computing devices and/or systems.

In examples, the coverage data generation system 110 may also, or instead, interact with a vendor device 130 that request coverage data from the coverage data generation system 110. For example, the vendor device 130 may be a device operated by a vehicle vendor (e.g., dealer) for purposes of obtaining vehicle insurance coverage data, for instance, to facilitate the acquisition of a vehicle by a customer of the vehicle vendor. The vendor device 130 may be configured with an interface generation application 132 that may facilitate interaction with a vendor user by generating interfaces and other data that may be presented, via components of the vendor device 130, as output to a vendor user visually, audibly, haptically, and/or via any other output means. The interface generation application 132 may further facilitate interaction with a vendor user by accepting or otherwise detecting input from a vendor user via components of the vendor device 130, including touch input (e.g., using buttons and/or a touchscreen), audible input (e.g., using a microphone), visual input (e.g., using a camera or other light-sensitive input means), haptic input (e.g., using motion sensors to detect movement of the vendor device 130 by a user), etc. In various examples, the interface generation application 132 may be, or include, a web browser or other application that facilitates interaction with one or more remote systems or devices.

The vendor device 130 may also, or instead, be configured with a coverage application 134. The coverage application 134 may be an application configured to interact with the coverage data generation system 110. The coverage application 134 may be executed independently of the interface generation application 132 and may receive input and generate output independent of the interface generation application 132 (e.g., using components of the vendor device 130), including any input and output as described herein. Alternatively, the coverage application 134 may be executed in conjunction with the interface generation application 132 that may interact with the coverage application 134 to perform various operations.

The vendor device 130 may include one or more wireless and/or wired communications components that may facilitate interaction with remote devices and/or systems. For example, the vendor device 130 may include various wireless and/or wired communications components that may facilitate communications (e.g., the exchange of coverage data-related communications) with one or more remote systems via the network 150. These communications may be wireless communications transmissions, using, for example, cellular communications, Bluetooth communications, and/or Wi-Fi.

The user device 120 may exchange, based on execution of the interface generation application 122 and/or the coverage application 124, coverage request data 160 with the coverage data generation system 110. This exchange may include a request for coverage data transmitted by the user device 120 to the coverage data generation system 110 via the network 150. This exchange may further include additional requests for information from the coverage data generation system 110 and responsive communications generated by the user device 120, for example, based on input solicited from the user of the device via interfaces and so forth. Additional details are provided herein regarding such interactions and data collection.

Similarly, the vendor device 130 may exchange, based on execution of the interface generation application 132 and/or the coverage application 134, coverage request data 170 with the coverage data generation system 110. This exchange may also include a request for coverage data transmitted by the vendor device 130 to the coverage data generation system 110 via the network 150. This exchange may further include additional requests for information from the coverage data generation system 110 and responsive communications generated by the vendor device 130, for example, based on input solicited from the vendor user of the vendor device 130 via interfaces and so forth. Additional details are provided herein regarding such interactions and data collection.

Data exchanges with remote devices may be processed at an application interaction component 111 of the coverage data generation system. Any component of the coverage data generation system 110, including the application interaction component 111, may be a software component, a hardware component, or a combination thereof configured at the coverage data generation system 110. In examples, the application interaction component 111 may be a microservice of a coverage data generation application executing at the coverage data generation system 110. In examples, any component of the coverage data generation system 110, including the application interaction component 111, may be implemented physically and/or logically distinctly from any other component of the coverage data generation system 110. Alternatively, any component of the coverage data generation system 110, including the application interaction component 111, and any function or operation performed thereby, may be at least partially integrated into or otherwise implemented in combination with any other component of the coverage data generation system 110. All such implementations are contemplated as within the scope of the instant disclosure.

The remote application interaction component 111 may process data received via such exchanges (e.g., from the user device 120 and/or the vendor device 130 via the network 150) to generate or otherwise determine data to be provided to other components of the coverage data generation system 110. The remote application interaction component 111 may also, or instead, process data received from other components of the coverage data generation system 110 to generate and transmit communications data (e.g., as frames, packets, etc.) to remote devices or systems, such as the user device 120 and/or the vendor device 130 via the network 150. The application interaction component 111 may further generate instructions to be executed at remote devices and/or systems that may, for example, cause such devices and/or systems to present interfaces, generate audible, visual, and/or haptic output, request input, etc.

In examples, the application interaction component 111 may determine coverage data generation operations and generate instructions to be executed at various components of the coverage data generation system 110 to perform such operations. For example, a request for coverage data may be received from the user device 120 and/or the vendor device 130. In response to this request, the application interaction component 111 may determine one or more operations to be performed to satisfy the request. The application interaction component 111 may then generate and transmit instructions and data to various components of the coverage data generation system 110 to perform such operations and collect data required to satisfy the request. If there is data needed to perform such operations that is not contained within the request, the application interaction component 111 may interact with the sender of the request to obtain such data. For example, user identification data and/or vehicle data may be needed to complete various coverage data generation operations. In the absence of at least a portions of such data, the application interaction component 111 may interact with the sender of the request to request such data.

A request for coverage data received from the user device 120 and/or the vendor device 130 may include user identification data. This data may be collected, for example, through an interface presented to a user on the user device 120 and/or the vendor device 130. In examples, the user identification information may include contact data (e.g., a telephone number or an email address) and date-of-birth (DOB) information (e.g., a day, month, and year of the birth of the user associated with the request for coverage data, or a representation thereof). In examples, the request for coverage data may also include vehicle-related information (e.g., make, model, year, vendor, condition, etc.). Among vehicle-related information and/or included with a coverage request may be a date of possession indicating the date on which the user intends to take possession of the vehicle for which coverage data is being requested. For example, the data of possession may be the date of purchase or lease of the vehicle.

As a coverage data generation operation determined in response to a request for coverage data, the application interaction component 111 may generate instructions to determine customer-related information, such as a customer identifier, an account identifier, a region, an address, a ZIP code, etc. based on the user identification information. The application interaction component 111 may transmit these instructions to a user data determination component 112 of the coverage data generation system 110. The user data determination component 112 may interact with a user data store 140 to determine a customer identifier, account identifier, address, and/or other customer-related information (e.g., vehicle-related information such as make, model, year, vendor, condition, etc. for one or more vehicles) associated with the user identification information. The user data store 140 may be any type of data store, database, storage service, etc. that may be local or remote to the coverage data generation system. In examples, the user data determination component 112 may query the user data store 140 using the user identification information to obtain a customer identifier or account identifier (e.g., that may be an internal identifier or key uniquely associated with a particular customer or user) as well as any other customer-related information.

The user data determination component 112 may return the customer-related information (e.g., customer identifier, account identifier, region, address, ZIP code, etc.) to the application interaction component 111. The application interaction component 111 may then generate, as a coverage data generation operation determined in response to the customer-related information, instructions to determine policy data for a policy associated with the customer-related information. The application interaction component 111 may transmit these instructions, along with at least a subset of the customer-related information, to a policy data determination component 113 of the coverage data generation system 110. Alternatively, the user data determination component 112 may transmit at least a subset of the customer-related information (e.g., the customer identifier or account identifier) to the policy data determination component 113 along with instructions to determine policy data for a policy associated with the customer-related information. In another alternative, the policy data determination component 113 may be configured to determine policy data for a policy associated with the customer-related information (e.g., a customer identifier or an account identifier) in response to receiving the customer-related information from either the user data determination component 112 or the application interaction component 111.

The policy data determination component 113 may interact with a policy data store 142 to determine policy data associated with the customer-related information. The policy data store 142 may be any type of data store, database, storage service, etc. that may be local or remote to the coverage data generation system. In examples, the policy data determination component 113 may query the policy data store 142 using, for example, the customer identifier or account identifier to obtain policy data for a policy associated with the customer identifier or account identifier. For example, such policy data may include extended coverage data (e.g., limits, deductibles, temporary coverage duration, etc.) that may be associated with a customer's current vehicle insurance policy. In another example, such policy data may also, or instead, include current coverage data (e.g., limits, deductibles, cost, policy duration, etc.) that may be associated with a customer's current vehicle insurance policy. Such policy data may also, or instead, include vehicle-related information such as make, model, year, vendor, condition, etc. for one or more vehicles that may be associated with a policy represented by the policy data.

The policy data determination component 113 may return the policy data to the application interaction component 111. The application interaction component 111 may then generate, as a coverage data generation operation determined in response to the policy data, instructions to determine regional data for a region associated with the customer-related information. For example, particular jurisdictions (e.g., states, territories, provinces) may have particular extended insurance coverage requirements (limits, deductibles, duration, etc.) that are required regardless of the features of an associated insurance policy. The application interaction component 111 may transmit these instructions, along with at least a subset of the customer-related information that indicates the region associated with the customer associated with the customer-related information, to a regional data determination component 114 of the coverage data generation system 110. In some examples, the application interaction component 111 may also transmit at least a subset of vehicle-related information to the regional data determination component 114 (e.g., where regional requirements may vary by vehicle type, year, model, make, etc., or based on other vehicle attributes). Alternatively, the user data determination component 112 and/or the policy data determination component 113 may transmit at least a subset of the customer-related information representing a region (and, in some cases, vehicle-related information) to the regional data determination component 114 along with instructions to determine regional data for a region associated with the customer-related information. In another alternative, the regional data determination component 114 may be configured to determine regional data for a region associated with the customer-related information in response to receiving the customer-related information (and, in some cases, vehicle-related information) from either the user data determination component 112, the policy data determination component 113, and/or the application interaction component 111.

The regional data determination component 114 may interact with a regional data store 144 to determine regional data associated with the region indicated in the customer-related information (and, in some cases, vehicle-related information). The regional data store 144 may be any type of data store, database, storage service, etc. that may be local or remote to the coverage data generation system. In examples, the regional data determination component 114 may query the regional data store 144 using a region identifier, such as a ZIP code or a state code (and, in some cases, vehicle-related information), to obtain regional coverage data for the region associated with the region identifier. For example, such regional data may include extended coverage data (e.g., limits, deductibles, temporary coverage duration, etc.) that may be required in the associated region or representing a minimum of coverage required in the associated region.

The regional data determination component 114 may return the regional data to the application interaction component 111. The application interaction component 111 may then generate, as a coverage data generation operation determined in response to the regional data, instructions to determine coverage data. For example, the request for coverage data may have been a request for extended coverage data, predicted coverage data, or both. The application interaction component 111 may transmit these instructions, along with at least a subset of the customer-related information, the policy data, the regional data, and/or vehicle-related information, to a coverage data determination component 115 of the coverage data generation system 110. Alternatively, the user data determination component 112, the policy data determination component 113, and/or the regional data determination component 114 may transmit their respectively determined data along with instructions to determine coverage data to the coverage data determination component 115. In another alternative, the coverage data determination component 115 may be configured to determine coverage data in response to receiving the customer-related information, policy data, regional data, and/or vehicle-related information from any one or more of the user data determination component 112, the policy data determination component 113, the regional data determination component 114, and/or the application interaction component 111.

The coverage data determination component 115 may perform operations to determine coverage data using the received customer-related information, policy data, regional data, and/or vehicle-related information. In examples, the coverage data determination component 115 may include an extended coverage data determination component 116 that may be configured to determine extended coverage data. For example, using the received customer-related information, policy data, regional data, and/or vehicle-related information, the extended coverage data determination component 116 may determine applicable extended coverage data (e.g., limits, duration, deductibles, etc.). In some examples, the extended coverage data determination component 116 may be configured to resolve contradictory or inconsistent coverage data. For instance, where the attribute of duration of coverage indicated by policy data differs from the attribute of duration of coverage indicated by regional data, the extended coverage data determination component 116 may determine a duration of coverage for extended coverage data that is the longer of the two based on a comparison of one attribute to another and selecting the longer of the two for inclusion in the coverage data. Other inconsistent coverage data may be similarly resolved. In examples, the extended coverage data determination component 116 may ensure that at least the coverages required by the regional data are included in the extended coverage data to ensure compliance with regional laws and regulations. In further examples, the extended coverage data determination component 116 may ensure that any coverages included with the policy data that are more extensive than those of the regional data are included in the extended coverage data to ensure that the customer receives the coverage included with the customer's policy.

The extended coverage data determination component 116 may provide the resulting extended coverage data to the application interaction component 111, for example as an extended coverage data structure. Alternatively, the application interaction component 111 may generate an extended coverage data structure based on the extended coverage data determined by and received from the extended coverage data determination component 116. The application interaction component 111 may generate an extended coverage data communication 180 that may include this data structure and/or data based thereon. For example, the extended coverage data structure may include limit data 182, deductible data 184, and/or duration data 186. This data may be represented in the extended coverage data communication 180. The application interaction component 111 may transmit the extended coverage data communication 180 to the user device 120, via the network 150, as a response to a request for coverage data received as coverage request data 160. Alternatively or additionally, the application interaction component 111 may transmit the extended coverage data communication 180 to the vendor device 130, via the network 150, as a response to a request for coverage data received as coverage request data 170.

In examples, one or both of the coverage request data 160 and the coverage request data 170 may include a request for predicted coverage data, e.g., a request for a quote for a new, renewable insurance policy for a vehicle (as opposed to a temporary insurance policy associated with extended coverage data). As with a request for extended coverage data, a request for predicted coverage data may include vehicle-related information. A request for predicted coverage data may further include a policy type and/or one or more policy parameters that may be used to determine predicted coverage data. For example, as described in more detail herein, this request may indicate whether the predicted coverage data is to be for a collision policy, a comprehensive policy, a policy similar to a customers' existing policy, a policy with one or more specified terms (e.g., limits, deductibles, durations, etc.), any other type of custom policy, etc.

In such examples, the coverage data generation system may perform similar operations as described herein for extended coverage data generation but adjusted to determine predicted coverage data. For example, the coverage data determination component 115 may perform operations to determine predicted coverage data using the received customer-related information, policy data, regional data, and/or vehicle data determined as described herein. In this example, the coverage data determination component 115 may include a predicted coverage data determination component 117 that may be configured to determine predicted coverage data. For example, using the received customer-related information, policy data, regional data, and/or vehicle data, the predicted coverage data determination component 117 may determine applicable predicted coverage data (e.g., limits, duration, deductibles, etc.). In some examples, the predicted coverage data determination component 117 may be configured to resolve contradictory or inconsistent coverage data. For instance, where the limits of a requested policy type do not meet the minimum limits indicated by regional data, the predicted coverage data determination component 117 may determine limits for predicted coverage data that meet the regional requirements. Other inconsistent coverage data may be similarly resolved.

The predicted coverage data determination component 117 may provide the resulting predicted coverage data to the application interaction component 111, for example as a predicted coverage data structure. Alternatively, the application interaction component 111 may generate a predicted coverage data structure based on the predicted coverage data determined by and received from the predicted coverage data determination component 117. The application interaction component 111 may generate a predicted coverage data communication 190 that may include this data structure and/or data based thereon. For example, the predicted coverage data structure may include limit data 192, deductible data 194, and/or duration data 196. This data may be represented in the predicted coverage data communication 190. The application interaction component 111 may transmit the predicted coverage data communication 190 to the user device 120, via the network 150, as a response to a request for predicted coverage data received as coverage request data 160. Alternatively or additionally, the application interaction component 111 may transmit the predicted coverage data communication 190 to the vendor device 120, via the network 150, as a response to a request for predicted coverage data received as coverage request data 170.

A request for coverage data may also trigger one or more related operations. For example, the coverage data generation system 110 may, in response to processing a request for extended coverage data and/or predicted coverage data, may generate one or more notifications for an agent or other insurer representative associated with the requesting user and/or the user's policy, account, etc. The coverage data generation system 110 may also, or instead, generate one or more tasks for such an agent and/or initiate other operations.

The coverage data generation system 110 may include a task generation component 118 that may generate tasks and perform other operations related to generating coverage data. The task generation component 118 may generate a communication that may be transmitted to an agent device 126 (that may be any type of computing device as described herein), such as an email or a text message, that may include at least a subset of the data used to generate coverage data and/or other data, such as at least a subset of the coverage data, a date and time of processing of the request for coverage data, and/or additional language prompting an agent to take further actions based on the request for coverage data. Alternatively or additionally, the task generation component 118 may generate instructions to present an interface or other output to an agent at the agent device 126. Such communications or instructions may be transmitted as follow-up task data 128 to the agent device 126.

By automating the operations needed to determine coverage data that is not readily available without significant human interaction (often only during business hours), the systems and techniques described herein improve the efficiency of coverage data determinations in particular and vehicle acquisitions as a whole. Moreover, by using the automated system described herein, agent notifications and other operations are automatically implemented, greatly reducing the time and resources (especially human) needed to appropriately ensure that customer needs are addressed. Moreover, using a centralized coverage data system to perform the disclosed operations greatly increases the efficiency of insurance information storage and processing systems generally. For example, fewer human telephone agents are needed as many customers will be able to obtain coverage data using the disclosed coverage data generation systems. The data provided will also be more accurate as there will be fewer opportunities for human error. Overall network and computing resource utilization will be reduced as the use of the disclosed coverage data generation systems will reduce the traffic on networks and systems generated by human operators attempting to determine coverage data for customers. Thus, the disclosed systems and methods provide a faster and more efficient way to reduce coverage data determination costs compared to traditional techniques of manually requesting and determining coverage data.

The disclosed systems and techniques are applicable to many scenarios involving vehicles and systems of any type. For example, the coverage data described herein may be vehicle insurance coverage data relevant to vehicle acquisitions. In other examples, the coverage data described herein may be coverage data applicable to vehicle rental or usage. In other examples, the coverage data described herein may be coverage data applicable to other insurable objects, such as houses, boats, animals, etc. As will be appreciated, the disclosed systems, techniques, and frameworks may be applied to many other scenarios and all such applications are contemplated as within the scope of the instant disclosure.

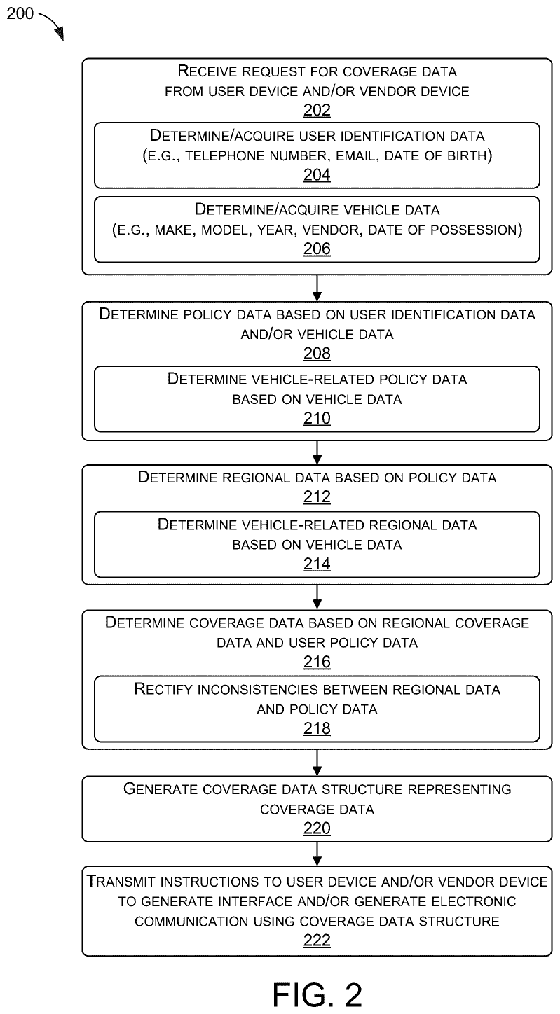

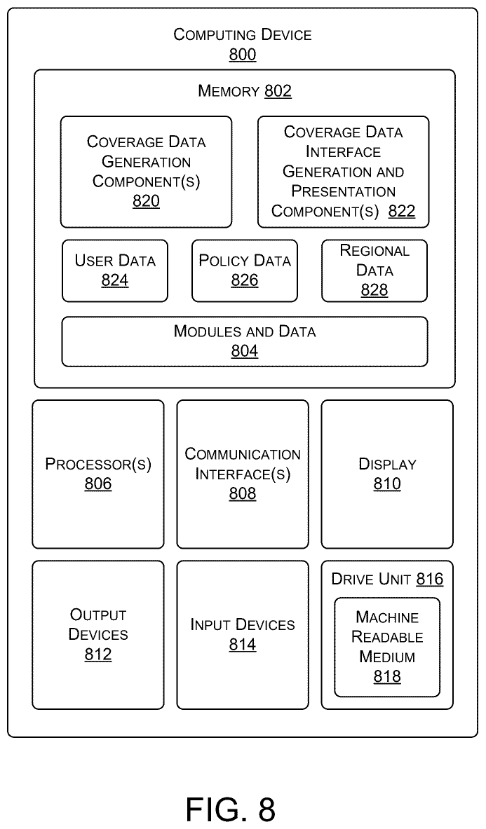

FIG. 2 is a flow diagram of an example process 200 for generating coverage data. In examples, one or more operations of the process 200 may be implemented by a user device or a coverage data generation system, such as by using any one or more of the components and systems illustrated in FIG. 1 and described above and/or by using any one or more of the components and systems illustrated in FIG. 8 and described below. For example, one or more such components and systems can include those associated with the user device 120, the vendor device 130, and/or the coverage data generation system 110 illustrated in FIG. 1. One or more such components and systems can also, or instead, include those associated with the computing device 800 illustrated in FIG. 8. In other examples, one or more operations of the process 200 may be performed by a combination of components described in regard to these systems and/or other systems. However, the process 200 is not limited to being performed by such components and systems, and the components and systems described herein are not limited to performing the operations of the process 200.

At operation 202, a coverage data generation system may receive a request for coverage data from a source device, such as a user device or a vendor device. This request for coverage data may be a request for extended coverage data, a request for predicted coverage data, a request for current coverage data (e.g., for a currently active renewable policy), a request for historical coverage data (e.g., for a formerly active renewable policy), a request for any other type of coverage data, or any combination thereof. This request for coverage data may include and/or initiate acquisition of various types of data that may be used in performing coverage data generation operations.

The received request may be generated by a user device executing a browser based on activation of a control on a user interface (e.g., a graphical user interface (GUI)) that generates, in response to the browser detecting this control activation, the request received at 202. The browser may have stored, in user device memory, user information, such as username, telephone number, date of birth, full name, email address, etc., during a user authentication process (e.g., logging onto a website on which a coverage data request interface may be presented following successful user authentication). For instance, the website facilitating presentation of a coverage data request interface may use a multi-factor authentication operation that stores user information in memory that may then be used in the generation of a received request for coverage information, such as the request received at 202.

For example, at operation 204, the coverage data generation system may determine or acquire user identification data based on the received request. In examples, the coverage data generation system may identify such user identification data represented in the received request (e.g., from user data payload in one or more data packets and/or frames). This data may include, but is not limited to, a user's telephone number, an email address, and a date of birth. However, if user identification data that is needed to perform coverage data generation operations is not represented in the received request, the coverage data generation system may, at operation 204, acquire such data via interaction with the source device. For example, the coverage data generation system may transmit instructions to the source device that cause the source device to generate and present an interface soliciting input from a user. The solicited input may represent the needed user identification data. When provided by the user, the source device may transmit the input representing the user identification data to the coverage data generation system. These operations may be performed multiple times until the needed user identification information is obtained. If the coverage data generation system ultimately determines that needed user identification data is unobtainable, the process 200 may terminate, in examples, with the coverage data generation system providing a failure message to the user via instructions transmitted to the source device for presentation of such a failure message.

Operation 204 may further include determining one or more customer, user, or account identifiers based on the user identification data. For example, the user identification data may be a telephone number and date of birth. The coverage data generation system may use this telephone number and date of birth to determine (e.g., from a database, data store, storage service, etc.) a user or customer number that uniquely instead, use this telephone number and date of birth to determine (e.g., from a database, data store, storage service, etc.) an account number that uniquely identifies a particular user or customer account. In examples, rather than perform queries to determine user, customer, and/or account numbers or identifiers, the coverage data request may include such data and/or the coverage data generation system may acquire such data via interaction with the source device, for instance, as described herein.

In examples, the request for coverage data may also, or instead, include and/or initiate acquisition of vehicle data. For example, at operation 206, the coverage data generation system may determine or acquire vehicle data based on the received request. This may be data indicating a vehicle for which coverage data is requested (e.g., a vehicle for which a customer is contemplating an acquisition, a newly acquired vehicle, a currently insured vehicle, etc.). In examples, the coverage data generation system may identify such vehicle data represented in the received request (e.g., from user data payload in one or more data packets and/or frames). Vehicle data may include a vehicle make, model, and year. Vehicle may also, or instead, be a specific vehicle identifier, such as a license plate number or a vehicle identification number (VIN). The vehicle data may further, or instead, include an identifier of a vehicle vendor, such as a car dealer. The vehicle data may also, or instead, include a date of possession indicating the date on which the user intends to take possession of the vehicle for which coverage data is being requested. For example, the data of possession may be the date of purchase or lease of the vehicle. In examples, the data of possession may be automatically included in the request by the user device and/or by the browser executing on the device by automatically including a current (present) date in the request. The system may then use this current date as the date of possession. Alternatively, the system may, when performing various operations described herein, independently determine a current date (e.g., a date at which the request for coverage data was received) and use that date as the date of possession.

If vehicle data that is needed to perform coverage data generation operations is not represented in the received request, the coverage data generation system may, at operation 206, acquire such data via interaction with the source device. For example, the coverage data generation system may transmit instructions to the source device that cause the source device to generate and present an interface soliciting input from a user. The solicited input may represent the needed vehicle data. When received as input by the user, the source device may transmit the input representing the vehicle data to the coverage data generation system. As with the user identification data acquisition process, these operations may be performed multiple times until the needed vehicle data is obtained. If the coverage data generation system ultimately determines that needed vehicle data is unobtainable, the process 200 may terminate, in examples, with the coverage data generation system providing a failure message to the user via instructions transmitted to the source device for presentation of such a failure message.

At operation 208, using user and/or vehicle identifying information (e.g., user identifier, customer identifier, account identifier, vehicle data, etc.), the coverage data generation system may determine policy data associated with a customer and/or vehicle. For example, the coverage data generation system may query a policy data store (e.g., database, data store, storage service, etc.) using a customer identifier or an account identifier to access and retrieve policy data, such as limits, deductibles, duration, etc. The coverage data generation system may request or otherwise access specifically extended coverage policy data, predicted coverage policy data, or any other particular type of policy data. Alternatively, the coverage data generation system may request all policy data related to a customer identifier or account identifier and then process that data to determine the specific policy data needed to satisfy the coverage data request.

In some examples, where vehicle data is available, at operation 210, the coverage data generation system may determine vehicle-related policy data using this vehicle data. For example, the request may be for extended coverage data or current coverage data for a current policy. In such examples, the request may indicate, and/or the coverage data generation system may determine, a particular vehicle that is currently insured on a particular policy based on vehicle data received or acquired from the source device. The coverage data generation system may then identify that policy (e.g., based on a VIN or license plate number) and access or retrieve the policy data associated with that policy. Alternatively, where the request may be for predicted coverage data, the coverage data generation system may determine predicted policy data based on the potentially insured vehicle that may be indicated in the request and/or determined by the coverage data generation system (e.g., via interaction with the source device). The coverage data generation system may then use current policy information for the customer and vehicle data for the potentially insured vehicle to determine predicted coverage data.

At operation 212, the coverage data generation system may determine regional data based on a region associated with a user, customer, or policy. Regional data may be particular policy requirements associated with a geographical or legally-define region. For example, particular jurisdictions (e.g., states, territories, provinces) may have particular extended insurance coverage requirements (limits, deductibles, duration, etc.) that are required regardless of the features of an associated insurance policy. In examples, the coverage data generation system may identify a region (e.g., state, territory, province, country, etc.) or otherwise determine a region identifier associated with the policy identified at operation 208 and/or the user, customer, and/or vehicle identified at operation 202. The coverage data generation system may then query or access a regional data store (e.g., database, data store, storage service, etc.) using the region identifier to access and retrieve regional coverage data, such as limits, deductibles, duration, etc. required by that region.

In some examples, this regional coverage data may be further dependent upon a type or use of vehicle. For instance, vehicle rentals may have different coverage requirements than newly acquired vehicles. In another example, commercial vehicles and/or heavy vehicles may have different coverage requirements than personal vehicles and/or light passenger vehicles. At operation 214, the coverage data generation system may also, or instead, query or access the regional data store using a vehicle identifier or other indicator of vehicle type and/or use to access and retrieve regional coverage data, such as limits, deductibles, duration, etc. required by that region for that type or use of vehicle.

At operation 216, the coverage data generation system may determine the applicable coverage data that will satisfy the request received at operation 202. For example, from the various coverage data determined in previous operations, the coverage data generation system may determine applicable (e.g., extended, predicted, etc.) coverage data, such as limits, deductibles, duration, etc. In examples, where there may be inconsistencies between determined coverage data, the coverage data generation system may, at operation 218, rectify these inconsistencies to generate applicable coverage data responsive to the request. For instance, a policy currently in force may include policy data, as determined at operation 208, that includes extended coverage data (e.g., limits, deductibles, duration, etc.) that differs from the required extended coverage data indicated in regional data determined at operation 212. In such cases, at operation 218, the coverage data generation system may determine responsive applicable coverage data that corresponds to the regional requirements or the policy requirements.

In an illustrative, non-limiting example, a region may require a one-month duration of extended coverage, while a particular policy may provide for only two weeks of extended coverage. In this case, the coverage data generation system may determine as applicable extended coverage data a duration of one month to ensure compliance with regional requirements. In another illustrative, non-limiting example, a region may require a two-week duration of extended coverage while a particular policy may provide for one month of extended coverage. In this case, the coverage data generation system may determine as applicable extended coverage data a duration of one month to ensure compliance with a policy that requires a longer duration of coverage than the minimum required by the region. Similar determinations may be performed for inconsistent deductibles, limits, and any other coverage data.

At operation 220, the coverage data generation system may generate one or more data structures representing the responsive applicable coverage data determined at operation 216. This may be a data structure comprising data units identifying and representing various pieces of coverage data (e.g., limits, deductibles, duration, etc.). In some examples, the data structure generated at operation 220 may be encrypted to ensure secure communications with the source device. To further ensure the security of the coverage data, the data structure generated at operation 220 may be a blockchain block containing the coverage data. In such examples, the coverage data generation system may generate an individual block of a blockchain for each type of coverage data (e.g., a block in a blockchain for current coverage data (coverage data for a currently in-force policy), another block in the blockchain for extended coverage data (extended coverage data associated with the currently in-force policy), and/or a block in a blockchain for predicted coverage data (coverage data for a contemplated vehicle acquisition)). Other types of distributed ledger operations may also, or instead, be used in the generation of the data structure representing the applicable coverage data. This data structure may also, or instead, be stored in one or more nodes that may be any type of computing device or entity, such as one or more cloud-based services or systems, along with the source device and/or the coverage data generation system. By using a blockchain block to provide the coverage data structure, the source device may then identify and verify (e.g., using blockchain block verification techniques) the data structure. In some examples, where multiple blocks are used in a blockchain, the coverage data generation system may generate a block representing the most recently requested coverage data structure and including a representation (e.g., a cryptographic hash, a cryptographic puzzle solution) of one or more previous blocks. In this way, the system may track and maintain the integrity of a series of coverage data requests and responses and/or other data associated with a particular user, customer, policy, vehicle, and/or transaction.

At operation 222, the coverage data system may transmit instructions, which may include the generated data structure of operation 220, to the source device to present or otherwise provide the coverage data to a device user. For example, the instructions may be interface generation instructions that may cause the source device to present, on a display, an interface that indicates the coverage data. The instructions may also, or instead, be instructions that may cause the source device to audibly indicate the coverage data and/or instructions that audibly notify the user of the availability of the coverage data. Alternatively or additionally, the instructions may be instructions transmitted and executed by a mail server, text server, voicemail server, or other intermediary device that cause the intermediary device to generate and transmit an electronic communication (e.g., an email, text, voicemail, etc.) indicating the coverage data to the source device. In examples, the instructions may include haptic output instructions that cause the source device to vibrate or otherwise generate tactile output that may be perceived by the user of the source device via touch. This haptic feedback may alert the user of the availability of the coverage data via an interface, electronic communication, etc. Any other means of communicating the availability and/or content of the coverage data may be used and are contemplated as within the scope of the instant disclosure.

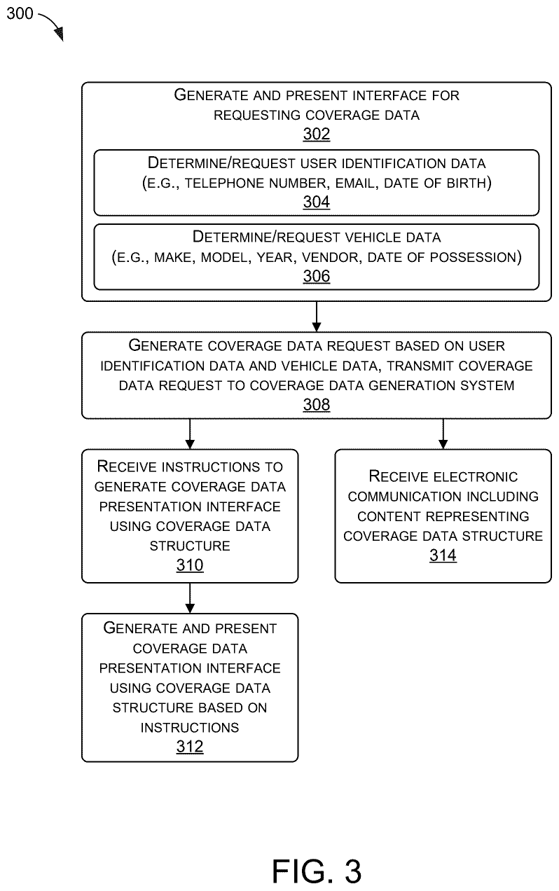

FIG. 3 is a flow diagram of an example process 300 for generating a request for coverage data and for receiving and providing such data. In examples, one or more operations of the process 300 may be implemented by a user device or a coverage data generation system, such as by using one or more of the components and systems illustrated in FIG. 1 and described above and/or by using one or more of the components and systems illustrated in FIG. 8 and described below. For example, one or more such components and systems can include those associated with the user device 120, the vendor device 130, and/or the coverage data generation system 110 illustrated in FIG. 1. One or more such components and systems can also, or instead, include those associated with the computing device 800 illustrated in FIG. 8. In other examples, one or more operations of the process 300 may be performed by a combination of components described in regard to these systems and/or other systems. However, the process 300 is not limited to being performed by such components and systems, and the components and systems described herein are not limited to performing the operations of the process 300.

At operation 302, a source device, such as a user device or vendor device, may generate and present an interface for requesting coverage data. This interface may be generated for and presented on a web browser or other application that facilitates interaction with one or more remote systems or devices. Alternatively, this interface may be generated and presented by a dedicated coverage data request or determination component (e.g., app) configured on the source device. This interface may be a visual interface displayed on a display of the source device and/or an audio interface configured to present audible output to the user and recognize audible (e.g., speech) input. Any other type of interface and/or means of presenting an interface for requesting coverage data may be used.

At operation 304, the source device may determine user identification data, for example, as input to the interface generated and presented at operation 302. For example, the user may enter, into text boxes or other input means presented on the interface, a date or birth, a telephone number, and/or an email address. Where vehicle data is collected, at operation 306, the source device may determine vehicle data, for example, as input to the interface generated and presented at operation 302. For example, the user may enter, into text boxes or other input means presented on the interface, a vehicle make, model, year, vendor, VIN, license plate number, etc.

At operation 308, the source device may generate a coverage data request based on the data collected at operations 304 and/or 306. In some examples, this may include the generation of a blockchain and the generation of an initial block in this blockchain represent the request data (e.g., user identification data and/or vehicle data). In such examples, the responsive coverage data transmitted to the source device may be represented in one or more subsequent blocks of this blockchain. Alternately or additionally, the request may be a packet or frame indicating the request and the associated data. Further at operation 308, the request may be transmitted to a coverage data generation system.

At operation 310, the source device may receive instructions from the coverage data generation system that may be responsive to the request transmitted at operation 308. In examples, these instructions may be interface generation instructions that may cause the source device to present, on a display, an interface that indicates the coverage data. Alternatively or additionally, the instructions may be instructions that cause the source device to audibly indicate the coverage data to the user and/or to audibly indicate the availability of the coverage data (e.g., via a visual interface) to the user. In examples, the instructions may also, or instead, include haptic output instruction that cause the source device to vibrate or otherwise generate tactile output that may be perceived by the user of the sources device via touch. This haptic feedback may alert the user of the availability of the coverage data via an interface, electronic communication, etc.

At operation 312, the source device may generate and present the coverage data based on (e.g., by executing) the instructions received at operation 310. This execution of the instructions may be based on the data structure received at operation 310 representing the coverage data. These instructions may be received and executed by a web browser or other remote device interaction facilitation application, by a dedicated coverage data application, and/or by any other suitable applications and/or hardware configured at the source device.

In some examples, the coverage data may also, or instead, be provided by the coverage data generation system in one or more electronic communications. In such examples, at operation 314, the source device may receive such communications and make the communication available to the user. For example, an email, text message, and/or voice message representing the coverage data (e.g., based on the coverage data structure) may be received at the source device. The user may then access the coverage data using the appropriate means (e.g., text messaging application, email application, voicemail application, etc.).

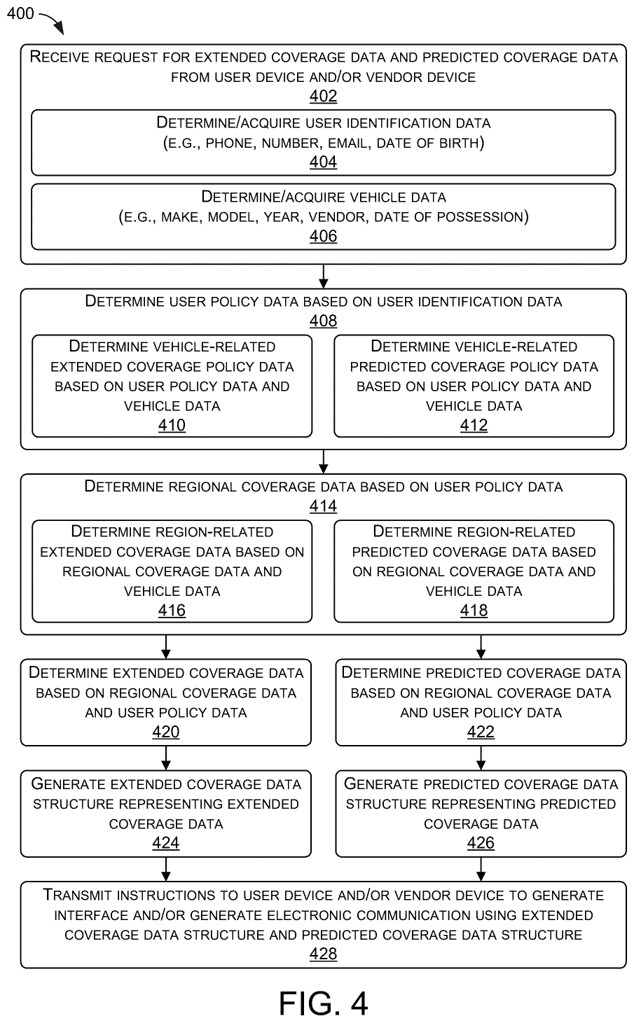

FIG. 4 is a flow diagram of an example process 400 for generating extended coverage data and predicted coverage data. In examples, one or more operations of the process 400 may be implemented by a user device or a coverage data generation system, such as by using one or more of the components and systems illustrated in FIG. 1 and described above and/or by using one or more of the components and systems illustrated in FIG. 8 and described below. For example, one or more such components and systems can include those associated with the user device 120, the vendor device 130, and/or the coverage data generation system 110 illustrated in FIG. 1. One or more such components and systems can also, or instead, include those associated with the computing device 800 illustrated in FIG. 8. In other examples, one or more operations of the process 400 may be performed by a combination of components described in regard to these systems and/or other systems. However, the process 400 is not limited to being performed by such components and systems, and the components and systems described herein are not limited to performing the operations of the process 400.

The example process 400 of FIG. 4 represents operations that may be performed in a common vehicle acquisition scenario. In such a scenario, a potential vehicle purchaser or lessee (referred to as “customer”) may be considering the acquisition of a vehicle, for instance, while at a car dealer. The customer may want to know the extended coverage details associated with the insurance policy currently in place for the customer's currently owned or leased vehicle and may want to receive a quote for a new insurance policy for a vehicle under consideration for acquisition. The customer may interact with an application as described herein to submit a request for both extended coverage data and predicted coverage data to a coverage data generation system. Alternatively, a vendor (e.g., a representative of the car dealer) may interact with an application as described herein to submit a request, on behalf of the customer, for both extended coverage data and predicted coverage data to a coverage data generation system.

At operation 402, the coverage data generation system may receive the request for extended coverage data and predicted coverage data from a source device operated by the customer or vendor. This request for coverage data may include and/or initiate acquisition of various types of data that may be used in performing coverage data generation operations.

For example, at operation 404, the coverage data generation system may determine or acquire user identification data based on the received request. In examples, the coverage data generation system may identify such user identification data represented in the received request (e.g., from user data payload in one or more data packets and/or frames). This data may include, but is not limited to, a user's telephone number, an email address, and a date of birth. However, if user identification data that is needed to perform coverage data generation operations is not represented in the received request, the coverage data generation system may, at operation 404, acquire such data via interaction with the source device. For example, the coverage data generation system may transmit instructions to the source device that cause the source device to generate and present an interface soliciting input from a user. The solicited input may represent the needed user identification data. When provided by the user, the source device may transmit the input representing the user identification data to the coverage data generation system. These operations may be performed multiple times until the needed user identification information is obtained. If the coverage data generation system ultimately determines that needed user identification data is unobtainable, the process 400 may terminate, in examples, with the coverage data generation system providing a failure message to the user via instructions transmitted to the source device for presentation of such a failure message.

Operation 404 may further include determining one or more customer, user, or account identifiers based on the user identification data. For example, the user identification data may be a telephone number and date of birth. The coverage data generation system may use this telephone number and date of birth to determine (e.g., from a database, data store, storage service, etc.) a user or customer number that uniquely instead, use this telephone number and date of birth to determine (e.g., from a database, data store, storage service, etc.) an account number that uniquely identifies a particular user or customer account. In examples, rather than perform queries to determine user, customer, and/or account numbers or identifiers, the coverage data request may include such data and/or the coverage data generation system may acquire such data via interaction with the source device, for instance, as described herein.

As noted, this request for coverage data may be a request for both extended coverage data and predicted coverage data. Accordingly, this request may include and/or initiate acquisition of vehicle data for the vehicle to be covered under the predicted coverage data. For example, at operation 406, the coverage data generation system may determine or acquire vehicle data based on the received request. This may be data indicating a vehicle for which coverage data is requested (e.g., a vehicle for which a customer is contemplating an acquisition, a newly acquired vehicle, a currently insured vehicle, etc.). In examples, the coverage data generation system may identify such vehicle data represented in the received request (e.g., from user data payload in one or more data packets and/or frames). Vehicle data may include a vehicle make, model, and year. Vehicle may also, or instead, be a specific vehicle identifier, such as a license plate number or a vehicle identification number (VIN). The vehicle data may further, or instead, include an identifier of a vehicle vendor, such as a car dealer. If vehicle data that is needed to perform coverage data generation operations is not represented in the received request, the coverage data generation system may, at operation 406, acquire such data via interaction with the source device. For example, the coverage data generation system may transmit instructions to the source device that cause the source device to generate and present an interface soliciting input from a user. The solicited input may represent the needed vehicle data. When received as input by the user, the source device may transmit the input representing the vehicle data to the coverage data generation system. As with the user identification data acquisition process, these operations may be performed multiple times until the needed vehicle data is obtained. If the coverage data generation system ultimately determines that needed vehicle data is unobtainable, the process 400 may terminate, in examples, with the coverage data generation system providing a failure message to the user via instructions transmitted to the source device for presentation of such a failure message.

At operation 408, using user and/or vehicle identifying information (e.g., user identifier, customer identifier, account identifier, vehicle data, etc.), the coverage data generation system may determine policy data associated with a customer and/or vehicle. For example, the coverage data generation system may query a policy data store (e.g., database, data store, storage service, etc.) using a customer identifier or an account identifier to access and retrieve policy data, such as limits, deductibles, duration, etc. The coverage data generation system may request or otherwise access specifically extended coverage policy data, predicted coverage policy data, or any other particular type of policy data. Alternatively, the coverage data generation system may request all policy data related to a customer identifier or account identifier and then process that data to determine the specific policy data needed to satisfy the coverage data request.

In examples, where the request received at operation 402 is a request for extended coverage data and predicted coverage data, at operation 410, the coverage data generation system may determine vehicle-related extended coverage policy data using this vehicle data. In such examples, the request may indicate and/or the coverage data generation system may determine a particular vehicle that is currently insured on a particular policy based on vehicle data received or acquired from the source device. The coverage data generation system may then identify that policy (e.g., based on a VIN or license plate number) and access or retrieve the extended coverage policy data associated with that policy.

At operation 412, the coverage data generation system may also determine predicted coverage policy data based on the potentially insured vehicle indicated by the vehicle data. The coverage data generation system may use current policy information for the customer and vehicle data for the potentially insured vehicle to determine predicted coverage data, for example, to provide a quote for coverage of the potentially insured vehicle similar to that of the current policy.

At operation 414, the coverage data generation system may determine regional data based on a region associated with a user, customer, or policy. Regional data may be particular policy requirements associated with a geographical or legally-define region. For example, particular jurisdictions (e.g., states, territories, provinces) may have particular insurance coverage requirements (limits, deductibles, duration, etc.) that are required regardless of the features of an associated insurance policy. In examples, the coverage data generation system may identify a region (e.g., state, territory, province, country, etc.) or otherwise determine a region identifier associated with the policy identified at operation 408 and/or the user, customer, and/or vehicle identified at operation 402. The coverage data generation system may then query or access a regional data store (e.g., database, data store, storage service, etc.) using the region identifier to access and retrieve regional coverage data, such as limits, deductibles, duration, etc. required by that region.

In some examples, this regional coverage data may be further dependent upon a type or use of vehicle. For instance, vehicle rentals may have different coverage requirements than newly acquired vehicles. In another example, commercial vehicles and/or heavy vehicles may have different coverage requirements than personal vehicles and/or light passenger vehicles. At operation 414, the coverage data generation system may also, or instead, query or access the regional data store using a vehicle identifier or other indicator of vehicle type and/or use to access and retrieve regional coverage data, such as limits, deductibles, duration, etc. required by that region for that type or use of vehicle.

At operation 416, the coverage data generation system may determine region-related extended coverage data for the vehicle to potentially be acquired, for example, based on regional extended coverage requirements. At operation 418, the coverage data generation system may determine region-related predicted coverage data for the vehicle to potentially be acquired, for example, based on regional standard or non-extended coverage requirements.

At operation 420, the coverage data generation system may determine the extended coverage data that will satisfy that portion of the request received at operation 402. For example, from the various extended coverage data determined in previous operations, the coverage data generation system may determine applicable extended coverage data, such as limits, deductibles, duration, etc. In examples, where there may be inconsistencies between, for example, regional extended coverage requirements and the extended coverage data associated with the customer's current policy, the coverage data generation system may, at operation 420, rectify these inconsistencies to generate applicable extended coverage data responsive to the request. For instance, a policy currently in force may include extended coverage policy data (e.g., limits, deductibles, duration, etc.), as determined at operation 408 and/or operation 410, that differs from the required extended coverage data indicated in regional data determined at operation 414 and/or operation 416. In such cases, at operation 420, the coverage data generation system may determine responsive applicable extended coverage data that corresponds to the regional requirements or the policy requirements, as described herein.

At operation 422, the coverage data generation system may determine the predicted coverage data that will satisfy that portion of the request received at operation 402. For example, from the various predicted coverage data determined in previous operations, the coverage data generation system may determine applicable predicted coverage data, such as limits, deductibles, duration, etc. In examples, where there may be inconsistencies between, for example, regional predicted (or standard) coverage requirements and the predicted (or current) coverage data associated with the customer's current policy, the coverage data generation system may, at operation 422, rectify these inconsistencies to generate applicable predicted coverage data responsive to the request. For instance, predicted coverage data (e.g., limits, deductibles, duration, etc.), as determined at operation 408 and/or operation 412, may differ from the required coverage data indicated in regional data determined at operation 414 and/or operation 416 for normal or standard policies (e.g., minimum legal coverage requirements). In such cases, at operation 420, the coverage data generation system may determine responsive applicable extended coverage data that corresponds to the regional requirements or the policy requirements, as described herein.

At operation 424, the coverage data generation system may generate one or more data structures representing the responsive extended coverage data determined at operation 420. This may be a data structure comprising data units identifying and representing various pieces of extended coverage data (e.g., limits, deductibles, duration, etc.). In some examples, the data structure generated at operation 424 may be encrypted to ensure secure communications with the source device. To further ensure the security of the coverage data, the data structure generated at operation 424 may be a blockchain block containing the extended coverage data.

At operation 426, the coverage data generation system may generate one or more data structures representing the responsive predicted coverage data determined at operation 422. This may be a data structure comprising data units identifying and representing various pieces of predicted coverage data (e.g., limits, deductibles, duration, etc.). In some examples, the data structure generated at operation 426 may be encrypted to ensure secure communications with the source device. To further ensure the security of the coverage data, the data structure generated at operation 426 may be another blockchain block containing the extended coverage data.

Other types of distributed ledger operations may also, or instead, be used at operation 424 and/or operation 426 for the generation of the data structure(s) representing the extended coverage data and the predicted coverage data. Such data structure(s) may also, or instead, be stored in one or more nodes that may be any type of computing device or entity, such as one or more cloud-based services or systems, along with the source device and/or the coverage data generation system. By using a blockchain block to provide the coverage data structure, the source device may then identify and verify (e.g., using blockchain block verification techniques) the data structure. In some examples, where multiple blocks are used in a blockchain, the coverage data generation system may generate a block representing the most recently requested coverage data structure and including a representation (e.g., a cryptographic hash, a cryptographic puzzle solution) of one or more previous blocks. In this way, the system may track and maintain the integrity of a series of coverage data requests and responses and/or other data associated with a particular user, customer, policy, vehicle, and/or transaction.

At operation 428, the coverage data system may transmit instructions, which may include the generated data structure(s) of 424 and/or operation 426, to the source device to present or otherwise provide the extended coverage data and the predicted coverage data to a device user. For example, the instructions may be interface generation instructions that may cause the source device to present, on a display, an interface that indicates the extended coverage data and the predicted coverage data. The instructions may also, or instead, be instructions that may cause the source device to audibly indicate the extended coverage data and/or the predicted coverage data, and/or instructions that audibly notify the user of the availability of the extended coverage data and the predicted coverage data. Alternatively or additionally, the instructions may be instructions transmitted and executed by a mail server, text server, voicemail server, or other intermediary device that cause the intermediary device to generate and transmit an electronic communication (e.g., an email, text, voicemail, etc.) indicating the extended coverage data and the predicted coverage data to the source device. In examples, the instructions may include haptic output instruction that cause the source device to vibrate or otherwise generate tactile output that may be perceived by the user of the sources device via touch. This haptic feedback may alert the user of the availability of the extended coverage data and the predicted coverage data via an interface, electronic communication, etc. Any other means of communicating the availability and/or content of the coverage data may be used and are contemplated as within the scope of the instant disclosure.

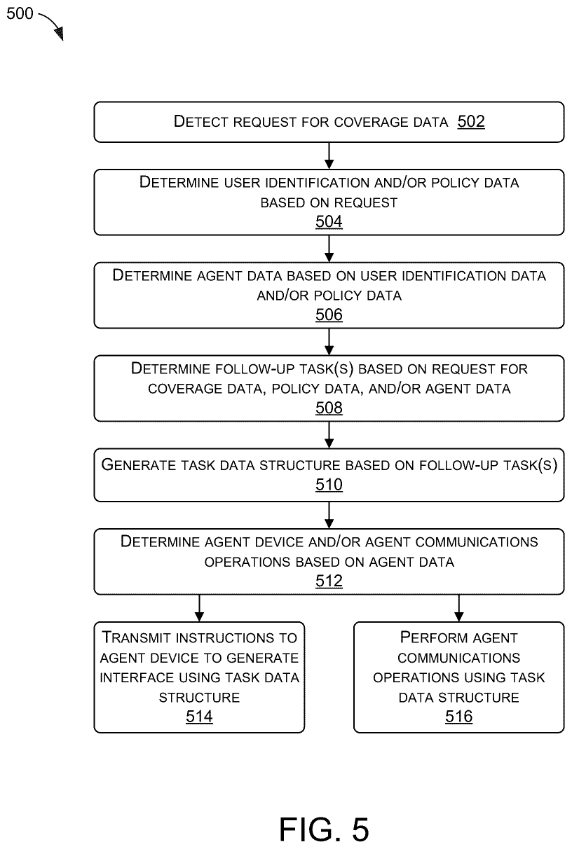

FIG. 5 is a flow diagram of an example process 500 for generating and executing agent communication operations. In examples, one or more operations of the process 500 may be implemented by a user device or a coverage data generation system, such as by using one or more of the components and systems illustrated in FIG. 1 and described above and/or by using one or more of the components and systems illustrated in FIG. 8 and described below. For example, one or more such components and systems can include those associated with the user device 120, the vendor device 130, and/or the coverage data generation system 110 illustrated in FIG. 1. One or more such components and systems can also, or instead, include those associated with the computing device 800 illustrated in FIG. 8. In other examples, one or more operations of the process 500 may be performed by a combination of components described in regard to these systems and/or other systems. However, the process 500 is not limited to being performed by such components and systems, and the components and systems described herein are not limited to performing the operations of the process 500.

At operation 502, a request for coverage data may be detected. This detection may be based on receipt of the request and/or the processing of the request. For example, the coverage data generation system may not initiate process 500 until a request for coverage data is successfully processed to ensure that agent notification operations are not performed in “false alarm” situations where a request may have been accidentally or unintentionally generated. In other examples, the coverage data generation system may initiate process 500 for each received request for coverage data to ensure that no such requests are unaddressed.

At operation 504, the coverage data generation system may determine user identification data, a user identifier, a customer identifier, an account identifier, and/or policy data, for example, as described herein. At operation 506, the coverage data generation system may identify an agent or other representative associated with the determined user, customer, account, or policy. In examples, each user, customer, account, or policy may be associated with one or more agents or representatives. Such correspondence data may be stored with policy data and/or customer data. Alternatively, such correspondence data may be stored in a distinct agent or representative data store, database, storage service, etc. At operation 506, the coverage data generation system may query or otherwise access such a data store to retrieve agent and/or representative information.

At operation 508, the coverage data generation system may determine one or more tasks or other operations to be initiated based on the request detected at operation 502. Particular request types may be associated with particular tasks or operations. For example, a request from a user for extended coverage data or predicted coverage data may, upon detection, initiate a task of generating and transmitting an electronic communication to the agent associated with the user, requesting the agent follow up with the user. This communication may include relevant known data, such as any of the vehicle data and/or user information. This communication may also, or instead, include any portion or all of the requested coverage data. Alternatively or additionally, an operation to generate and transmit instructions to an agent device causing that device to generate an interface on the device may be initiated in response to a request. In examples, an operation to generate and transmit instructions to an agent device causing that device to haptically notify the agent of a request and/or a related communication or interface may also, or instead, be initiated in response to a request. Any other task or operations may be determined based on detecting and/or processing a request for coverage data.

At operation 510, a task data structure may be generated for use with the operation(s) determined at operation 508. This data structure may include data units representing the request and/or any responsive coverage data generated as described herein. The task data structure may further include user information, vehicle information, and/or any other information that may be suitable for an agent task or communication.

The data structure may take the form of any data structure as described herein. For example, the initial request for coverage data may cause the coverage data generation system to initialize a blockchain and include the request as the first block in that blockchain. Each subsequent operation or data exchange may be added to the blockchain as a new block. Thus, the data structure generated at operation 510 may be added to the blockchain in a new block.

At operation 512, the particular means of communicating with the agent may be determined. For example, the coverage data generation system may determine a telephone number or email address for the agent. Alternatively or additionally, the coverage data generation system may determine an application that may be executing on an agent device. Any other means of communicating with an agent or otherwise performing operations related to agent communications operations or tasks may be determined at operation 512.

At operation 514, for any operations determined in the process 500 that include generation of interfaces at an agent device, the coverage data generation system may transmit instructions to the agent device that cause the agent device to generate and/or present one or more interfaces representing the task data structure. As with other interfaces described herein, this interface may be visual, audible, and/or haptic.

At operation 516, for any operations determined in the process 500 that include transmission of electronic communications to the agent device, the coverage data generation system may perform one or more operations that cause the transmission of such electronic communications to the agent device. For example, the coverage data generation system may transmit instructions to a text server, email server, voicemail server, etc. that cause the recipient device or system to generate and transmit an electronic communication based on the task data structure. In other examples, the coverage data generation system may transmit instructions to a customer relationship management (CRM) system or other system that may process this information to generate and transmit a notification or communication of any type intended for the agent. Any other means of providing electronic communications to the agent device may be used.

Operation 514 and operation 516 may be performed in conjunction. For example, the coverage data generation system may execute operation 516 to generate and transmit instructions to an email server to generate and transmit an email to the agent device or email account that indicates details of a request for coverage data submitted by a user. The coverage data generation system may also execute operation 514 to generate and transmit instructions to the agent device that cause the agent device to generate audible, visual, and/or haptic output notifying the agent that the email with coverage request information has been transmitted to the agent. Any other combination of operations and/or communications may be performed according to the disclosed embodiments.

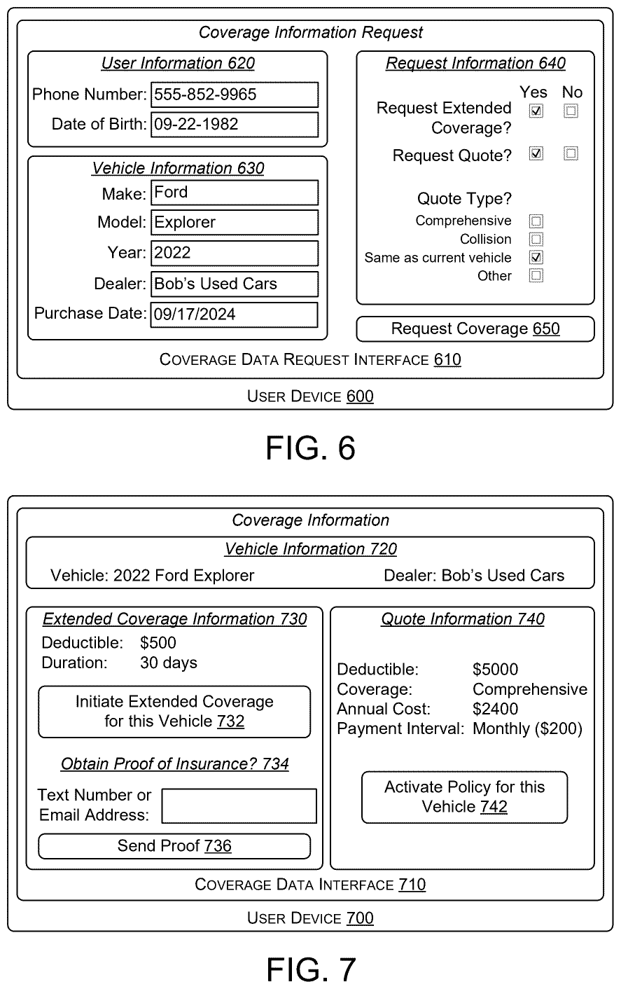

FIG. 6 illustrates an example coverage data request interface 610 that may be presented on a user device 600. The user device 600 may be any computing and/or user device described herein. The interface 610 may be generated by a computing system (e.g., the user device 120 or the vendor device 130 in FIG. 1) and/or a component of a coverage data generation system (e.g., the coverage data generation system 110 in FIG. 1) that may be configured to interoperate or otherwise control the user device 600 for facilitating the presentation and input of coverage data request data. The coverage data request interface 610 may be generated using data stored in a memory of a computing system and associated with an interface generation application (e.g., web browser, interface generation application 122, interface generation application 132, coverage application 124, or coverage application 134 in FIG. 1) and based on data received from another system, such as a coverage data generation system.

The interface 610 may facilitate the collection of user information that may be used in a request for coverage data. For example, the interface 610 may be generated by a web browser based on data associated with a webpage (e.g., hosted by an insurer system). Alternatively, the interface 610 may be generated by a coverage data determination and/or generation system that may at least partially be configured as an application on a user device.

The interface 610 may include a user information interface element 620 that may include one or more user data input elements, such as one or text boxes, drop-down boxes, or other input elements for providing a telephone number and a date of birth, as shown in this example. The interface 610 may also, or instead, include a vehicle information interface element 630 that may include one or more vehicle data input elements, such as one or text boxes, drop-down boxes, or other input elements for providing a make, model, year, dealer, and/or date of possession (in this example, shown as “purchase date”) as shown in this example.

The interface 610 may also, or instead, include a request information interface element 640 that may include one or more coverage data request data input elements, such as one or text boxes, drop-down boxes, or other input elements for providing request information. As shown here, a user may indicate that a request is to be a request for extended coverage data and/or predicted coverage data (e.g., a quote). Input elements may also be provided that allow a user to specify a quote type (e.g., from among one or more options, as shown here).

The interface 610 may also, or instead, include a user-selectable control element 650 that may initiate the request generation and transmission process. In examples, user activation of the control element 650 may cause the user device to generate a data structure representing the information input into the interface 610 by a user and transmit this data structure with a request for coverage data to a coverage data generation system. For instance, the information input into the interface 610 by the user may be stored in memory and associated with the browser or application generating the interface 610. In response to detecting the activation of the control element 650, this browser or application may retrieve this data and process it into a data structure. The data structure may then be packetized and transmitted to the coverage data generation system. The browser or application may have addressing and other needed communications data for the coverage data generation system also stored in memory and/or may determine such information from the webpage that the browser or application downloaded and used to generate and present the interface 610.

FIG. 7 illustrates an example coverage data interface 710 that may be presented on a user device 700. The user device 700 may be any computing and/or user device described herein. The interface 710 may be generated by a computing system (e.g., the user device 120 or the vendor device 130 in FIG. 1) and/or a component of a coverage data generation system (e.g., the coverage data generation system 110 in FIG. 1) that may be configured to interoperate or otherwise control the user device 700 for facilitating the presentation and input of coverage data request data. The coverage data interface 710 may be generated using data stored in a memory of a computing system and associated with an interface generation application (e.g., web browser, interface generation application 122, interface generation application 132, coverage application 124, or coverage application 134 in FIG. 1) and based on data received from another system, such as a coverage data generation system.

The interface 710 may facilitate the presentation of coverage data to a user and the initiation of related operations. For example, the interface 710 may be generated by a web browser based on data associated with a webpage (e.g., hosted by an insurer system) in response to a request for coverage data (e.g., as generated in FIG. 6). Alternatively, the interface 710 may be generated by a coverage data determination and/or generation system that may at least partially be configured as an application on a user device and further in response to a request for coverage data (e.g., as generated in FIG. 6).

The interface 710 may include a vehicle information interface element 720 that may include one or more vehicle data display elements, such as one or more textual, graphical, and/or audio elements that may indicate the year, make, model, and/or dealer associated with a vehicle for which coverage data is also displayed in the interface 710.

The interface 710 may also, or instead, include an extended coverage information element 730 that may include one or more extended coverage data display elements, such as one or more textual, graphical, and/or audio elements that may indicate an extended coverage deductible and/or an extended coverage duration, as shown here. Other extended coverage data may also, or instead, be presented in the extended coverage information element 730, such as coverage limits.

The interface 710 may also, or instead, include an extended coverage initiation control element 732 that may, when activated by a user, generates a request to initiate extended coverage for the vehicle indicated in the vehicle information interface element 720. This may facilitate ease of providing interim insurance coverage for a vehicle without requiring calling an agent or other representative to initiate such coverage.

The extended coverage information element 730 may also include one or more control elements and/or input elements that may allow a user to initiate further actions related to extended coverage. For example, the extended coverage information element 730 may include a proof of insurance request option 734 that may include an input element configured to receive a phone number and/or email address that may serve as a destination for proof of insurance, as shown in this example. The proof of insurance request option 734 may also, or instead, include a control element 736 configured to, upon activation by a user, generate and transmit a request for proof of insurance (e.g., extended coverage data) to be sent to the indicated telephone number or email address. For instance, a user may enter their own telephone number or email and/or a telephone number or email for a dealer that requires proof of insurance to complete the sale or lease of a vehicle. In some examples, activation of a control such as the control element 736 may cause the extended coverage data to be transmitted to a default contact (e.g., email address or telephone number), such as a contact associated with an existing policy, customer, or account. Note that activation of the control element 736 may also, or instead, trigger an agent communications operations (e.g., as described in regard to FIG. 5) that may communicate the extended coverage information and other information (e.g., vehicle information, user information, etc.) to an agent associated with the requesting customer or an associated policy.

The interface 710 may also, or instead, include a quote information element 740 that may include one or more predicted coverage data display elements, such as one or more textual, graphical, and/or audio elements that may indicate a predicted coverage deductible, type, cost, and/or payment intervals, as shown here. Other predicted coverage data may also, or instead, be presented in the quote information element 740, such as coverage limits.

The interface 710 may also, or instead, include a policy activation control element 742 that may, when activated by a user, generate a request to activate the quoted policy outlined in the quote information element 740 for the vehicle indicated in the vehicle information interface element 720. This may facilitate ease of initiating insurance coverage for a newly acquired vehicle without requiring calling an agent or other representative to activate such coverage.

FIG. 8 shows an example system architecture for a computing device 800 that may be implemented as (e.g., part of) any of the systems and devices described herein and/or may perform any of the operations and processes described herein. For example, the computing device 800 may represent any of the systems, devices, and components illustrated in FIG. 1. Moreover, the computing device 800 may represent any system configured to generate any of the interfaces described in regard to FIGS. 6 and 7 and/or any other interface described herein. Furthermore, the computing device 800 may represent any system configured to implement any of the operations described in regard to FIGS. 2-5 and/or any other operation described herein. The computing device 800 may be a server, computer, mobile device (e.g., smartphone, smartwatch), vehicle component, vehicle computing system, or any other type of computing device that may execute any of the operations described herein. In some examples, operations as described herein may be distributed among and/or executed by multiple computing devices 800.

A computing device 800 can include memory 802. In various examples, the memory 802 can include system memory, which may be volatile (such as RAM), nonvolatile (such as ROM, flash memory, etc.), or some combination of the two. The memory 802 may further include non-transitory computer-readable media, such as volatile and nonvolatile, removable and non-removable media implemented in any method or technology for storage of information, such as computer-readable instructions, data structures, program modules, or other data. System memory, removable storage, and non-removable storage are all examples of non-transitory computer-readable media.

Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by one or more computing devices 800. Any such non-transitory computer-readable media may be part of the computing devices 800.

The memory 802 may include modules and data 804 needed to perform operations as described herein by one or more computing devices 800. Included with such modules and data 804 and/or also stored in the memory 802 may be one or more coverage data generation components 820, one or more coverage data interface generation and presentation components 822, user data 824, policy data 826, and/or regional data 828. The coverage data generation component(s) 820 may perform any one or more of the operations related to coverage data generation as described herein. The coverage data interface generation and presentation component(s) 822 may also perform any one or more of the operations related to coverage data generation as described herein, as well as any one or more of the operations related to generating interfaces and/or other electronic communications as described herein. The user data 824 may be any vehicle data, user data, account data, customer data, (e.g., any data associated with user data store 140 of FIG. 1), and/or any related data described herein that may be stored in a memory such as memory 802 and/or used in any one or more of the operations related to coverage data generation as described herein. The policy data 826 may be any insurance policy data (e.g., any data associated with policy data store 142 of FIG. 1), and/or any related data described herein that may be stored in a memory such as memory 802 and/or used in any one or more of the operations related to coverage data generation as described herein. The regional data 828 may be any regional data, (e.g., any data associated with regional data store 144 of FIG. 1), and/or any related data described herein that may be stored in a memory such as memory 802 and/or used in any one or more of the operations related to coverage data generation as described herein.

One or more computing devices 800 may also have processor(s) 806, communication interface(s) 808, display(s) 810, output device(s) 812, input device(s) 814, and/or drive unit(s) 816 that may include one or more machine-readable media 818.

In various examples, the processor(s) 806 can be a central processing unit (CPU), a graphics processing unit (GPU), both a CPU and a GPU, or any other type of processing unit. Each of the one or more processor(s) 806 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 806 may also be responsible for executing computer applications stored in the memory 802, which can be associated with common types of volatile (RAM) and/or nonvolatile (ROM) memory.

The communication interfaces 808 may include transceivers, modems, interfaces, antennas, telephone connections, and/or other components that can transmit and/or receive data over networks, telephone lines, or other connections.

The display(s) 810 can be any one or more of a liquid crystal display or any other type of display commonly used in computing devices. For example, the display(s) 810 may include a touch-sensitive display screen that may also act as an input device or keypad, such as for providing a soft-key keyboard, navigation buttons, and/or any other type of input.

The output device(s) 812 may include any sort of output devices known in the art, such as the display(s) 810, one or more speakers, a vibrating mechanism, any other type of haptic mechanism, and/or a tactile feedback mechanism. Output devices 812 may also include one or more ports for one or more peripheral devices, such as headphones, peripheral speakers, and/or a peripheral display.

The input device(s) 814 may include any sort of input devices known in the art. For example, input device(s) 814 may include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine-readable media 818 of drive unit(s) 816 may store one or more sets of computer-executable instructions, such as software or firmware, that embodies any one or more of the methodologies or functions described herein. The instructions can also reside, completely or at least partially, within the memory 802, processor(s) 806, and/or communication interface(s) 808 during execution thereof by the one or more computing devices 800. The memory 802 and the processor(s) 806 may also constitute machine-readable media 818.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
receiving, at a cloud-based coverage data generation system, a request for coverage data associated with a service executing at the cloud-based coverage data generation system, the request for coverage data comprising user information and coverage data type;
determining, at the cloud-based coverage data generation system, and based on the user information, a user identifier;
determining, at the cloud-based coverage data generation system, and based on the user identifier and communication with a first data store, first coverage data associated with the coverage data type;
determining, at the cloud-based coverage data generation system, and based on the first coverage data and communication with a second data store, second coverage data associated with the coverage data type;
determining, at the cloud-based coverage data generation system, and based on the coverage data type, the first coverage data, and the second coverage data, third coverage data;
generating, at the cloud-based coverage data generation system and based on the third coverage data, presentation data that, when processed by a user computing device, cause the user computing device to output a subset of the third coverage data on an output component of the user computing device; and
transmitting, from the cloud-based coverage data generation system to the user computing device, the presentation data.

2. The method of claim 1, wherein determining the third coverage data comprises:
determining that a first coverage attribute of the first coverage data is inconsistent with a corresponding second coverage attribute of the second coverage data; and
selecting one of the first coverage attribute or the second coverage attribute for inclusion in the third coverage data based on a comparison of the first coverage attribute and the second coverage attribute.

3. The method of claim 1, wherein:
the first coverage data comprises policy coverage data associated with a policy currently associated with the user identifier, and
the second coverage data comprises regional coverage data associated with a region associated with the user identifier.

4. The method of claim 3, further comprising:
determining an agent device associated with the policy; and
transmitting an indication of the third coverage data to the agent device.

5. The method of claim 1, wherein the coverage data comprises extended coverage data for temporary coverage of a vehicle.

6. The method of claim 1, wherein the coverage data comprises predicted coverage data for future coverage of a vehicle.

7. The method of claim 1, wherein:
the request for coverage data further comprises vehicle data, and
determining at least one of the first coverage data or the second coverage data further based on the vehicle data.

8. A non-transitory computer-readable medium comprising instructions that, when executed by one or more processors at a cloud-based coverage data generation system, cause the one or more processors to perform operations comprising:
receiving a request for coverage data associated with a service executing at the cloud-based coverage data generation system, the request for coverage data comprising user information and coverage data type;
determining, based on the user information, a first identifier;
determining, based on the first identifier and communication with a first data store, first coverage data associated with the coverage data type;
determining, based on the first coverage data and communication with a second data store, second coverage data associated with the coverage data type;
determining, based on the coverage data type, the first coverage data, and the second coverage data, third coverage data;
generating, based on the third coverage data, presentation data that, when processed by a user computing device, cause the user computing device to output a subset of the third coverage data on an output component of the user computing device; and
transmitting, to the user computing device, the presentation data.

9. The non-transitory computer-readable medium of claim 8, wherein determining the third coverage data comprises:
determining that a first coverage attribute of the first coverage data is inconsistent with a corresponding second coverage attribute of the second coverage data; and
selecting one of the first coverage attribute or the second coverage attribute for inclusion in the third coverage data based on a comparison of the first coverage attribute and the second coverage attribute.

10. The non-transitory computer-readable medium of claim 8, wherein:
the first coverage data comprises coverage data associated with a policy currently associated with the first identifier, and
the second coverage data comprises regional data associated with a region associated with the first identifier.

11. The non-transitory computer-readable medium of claim 10, wherein the operations further comprise:
determining an agent device associated with the policy; and
transmitting an indication of the third coverage data to the agent device.

12. The non-transitory computer-readable medium of claim 8, wherein the first identifier is a vehicle identifier.

13. The non-transitory computer-readable medium of claim 12, wherein the vehicle identifier comprises a vehicle identifier number (VIN) or a license plate number.

14. A system comprising:
one or more processors; and
a non-transitory memory storing computer-executable instructions that, when executed, cause the one or more processors to perform operations comprising:
receiving a request for coverage data associated with a service executing at a cloud-based coverage data generation system, the request for coverage data comprising user information and coverage data type;
determining, based on the user information, a first identifier;
determining, based on the first identifier and communication with a first data store, first coverage data associated with the coverage data type;
determining, based on the first coverage data and communication with a second data store, second coverage data associated with the coverage data type;
determining, based on the coverage data type, the first coverage data, and the second coverage data, third coverage data;
generating, based on the third coverage data, presentation data that, when processed by a user computing device, cause the user computing device to output a subset of the third coverage data on an output component of the user computing device; and
transmitting, to the user computing device, the presentation data.

15. The system of claim 14, wherein the third coverage data comprises at least one of a coverage duration, a coverage deductible, and a coverage limit.

16. The system of claim 14, wherein the presentation data comprises an instruction to activate, at the user computing device, at least one of a visual output component, an audio output component, or a haptic output component.

17. The system of claim 14, wherein the presentation data comprises instructions to generate and present an interface representing the subset of the third coverage data at the user computing device.

18. The system of claim 14, wherein the coverage data type indicates one or more of:
extended coverage data,
current coverage data,
predicted coverage data, or
historical coverage data.

19. The system of claim 14, wherein the operations further comprise:
receiving a second request comprising one or more of a telephone number or an email address;
generating, based on the second request, second presentation data that, when processed by a second user computing device, causes the second user computing device to output a subset of the third coverage data on a second output component of the second user computing device; and
transmitting, to the second user computing device, using at least one of the telephone number or the email address, the second presentation data.

20. A system for generating coverage data, the system comprising:
means for receiving a request for coverage data associated with a service executing at a cloud-based coverage data generation system, the request for coverage data comprising user information and coverage data type;
means for determining, based on the user information, a user identifier;
means for determining, based on the user identifier and communication with a first data store, first coverage data associated with the coverage data type;
means for determining, based on the first coverage data and communication with a second data store, second coverage data associated with the coverage data type;
means for determining, based on the coverage data type, the first coverage data, and the second coverage data, third coverage data;
means for generating, based on the third coverage data, presentation data that, when processed by a user computing device, cause the user computing device to output at least a subset of the third coverage data on an output component of the user computing device; and
means for transmitting, to the user computing device, the presentation data.
